(19) United States
(12) Patent Application Publication
(10) Pub. No.: US 2024/0168599 A1
(43) Pub. Date: May 23, 2024

(54) ADDING INTERACTIVITY TO A LARGE FLOW GRAPH DRAWN AND RENDERED IN A CANVAS

(71) Applicant: VMware, LLC, Palo Alto, CA (US)

(72) Inventor: Suresh Nagar, Sunnyvale, CA (US)

(21) Appl. No.: 17/989,771

(22) Filed: Nov. 18, 2022

(51) Int. Cl. G06F 3/0481; G06F 3/04842; G06F 3/04845; G06T 11/00; G06T 11/20

(52) U.S. Cl. CPC G06F 3/0481; G06F 3/04842; G06F 3/04845; G06T 11/001; G06T 11/206; G06F 2203/04806; G06T 2200/24

(57) ABSTRACT

Some embodiments provide a novel method of providing user interactivity for a first image of a network. The method presents, in a display area of a graphical user interface (GUI), the first image of the network. The first image includes several component images corresponding to several network elements in the network. In some embodiments, none of the component images are GUI elements that are selectable in the GUI. The method detects a cursor action at a first location in the first image. The method identifies a particular component image by correlating the first location to a location of the particular component image in the first image. Then, the method performs a GUI action for a particular network element that corresponds to the particular component image.

### BACKGROUND

Rendering a large network graph in a browser can be a challenge because of browser limitations. There are two main means for rendering a large graph in a browser: (1) Scalable Vector Graphics (SVG) and (2) HTML5 Canvas. SVG resembles Extensible Markup Language (XML) and it easy to use and is interactive. However, one main drawback is that rendering thousands of objects causes the browser to slow down. HTML5 Canvas is able to render thousands of objects but it is not interactive. Any graph drawn using HTML5 canvas is a bitmap image and does not respond to mouse movements, hovers, clicks or any other user actions.

There have been efforts to make the canvas interactive and several approaches have been tried so far. In an offscreen canvas with color coding approach, another offscreen canvas is rendered where each node/link is rendered with a different color. An in-memory map of the color to the object is created and on the user interaction, the coordinates are picked from the main canvas and then the color is picked from the offscreen canvas. The object is then selected from the map against the color. This approach has the drawback that an offscreen canvas needs to be maintained and has to be kept in sync. Changing the color context in HTML5 is expensive and will slow down the graph readiness considerably. In a linear search approach, the links are not interactive. Only the nodes are made interactive, and on every mouse move, every node is linearly searched in memory to see if the mouse coordinates fall within the circle. This is extremely slow for large graphs and not a practical solution for thousands of nodes. Hence, methods and systems are needed for adding interactivity to a large flow graph drawn and rendered in HTML5 Canvas in a browser.

### BRIEF SUMMARY

Some embodiments provide a novel method of providing user interactivity for a first image of a network. The method presents, in a display area of a graphical user interface (GUI), the first image of the network. The first image includes several component images corresponding to several network elements in the network. In some embodiments, none of the component images are GUI elements that are selectable in the GUI. The method detects a cursor action at a first location in the first image. The method identifies a particular component image by correlating the first location to a location of the particular component image in the first image. Then, the method performs a GUI action for a particular network element that corresponds to the particular component image.

In some embodiments, the cursor action is detected by identifying that the first location is a current location of a cursor over the first image. As a user moves a cursor (or a mouse) across the first image in the GUI's display area, the method of some embodiments receives notification that the cursor has moved and receives spatial coordinates of the cursor. The method is able to use the cursor's current location to determine whether the cursor is hovering over any component images displayed in the GUI.

If the cursor is hovering over a particular component image, the method then performs the GUI action by modifying the particular component image in the GUI by displaying the particular component image in a different representation. For instance, the method may display the particular component image in a bolded representation or a particular color representation in order to highlight the particular component image in the GUI for the user. The method may also or instead display in the display area data from a data storage regarding the particular network element. For example, if the particular network element is a machine in the network, the data displayed may be the machine's name, source network address, destination address, etc.

In some embodiments, the cursor action is detected by detecting a cursor click operation at the first location in the first image, and the method then displays data from a data storage regarding the particular network element. Data regarding a selected network element is in some embodiments only displayed upon a click or double click selection of the component image associated with the network element. The cursor click operation may be either a single or double click operation, and may be either a right or left click operation. In some embodiments, the selected network element is a particular data message flow exchanged between first and second machines in the network. In such embodiments, the data displayed in the display area can be at least one of (1) the number of data messages of the particular flow, (2) the direction of the particular flow (e.g., from the first machine to the second machine, or vice versa), and (3) an action applied to the data messages of the particular flow based on a particular middlebox service rule.

The particular middlebox service rule may be, for example, a firewall rule, and the action applied to the data messages may be to allow, drop, or block the data message. In some embodiments, the firewall rule applied to the data messages of the flow is applied because no rule has yet to be defined for these data messages. This type of action can be referred to as “unprotected” because the set of firewall rules that are enforced in the network do not protect the network from these data messages (e.g., if they should be blocked or dropped). The particular component image presented in the GUI for a data message flow is in some embodiments a line from the first machine to the second machine in a particular color corresponding to the action applied to the data messages of the particular flow. For example, for allowed, blocked, or unprotected data messages, the color may be green, blue, and red, respectively.

In some embodiments, the method correlates the first location to the location of the component image in the first image by confirming that the first location falls within a particular location range allocated in a memory space associated with the particular component image. Each component image in some embodiments is represented in a memory space by a rectangle and the spatial coordinates of every point taken up by that rectangle corresponding to the pixel coordinates of the component image in the first image. For instance, a rectangle is represented in a memory space for an object (e.g., a machine or a data message flow) displayed in a canvas (or raster) image. In the canvas image, the object can be represented as another shape, such as a line or a circle, and the rectangle for that object is stored in the memory space as a collection of coordinates encompassing the entire line or circle. The spatial coordinates of the entire rectangle are associated with that object and the object's location on the canvas image. To confirm that a mouse cursor is hovering over or clicking on the object's component image in the canvas, the method determines that the cursor's location (i.e., the first location) has spatial coordinates that fall within the set of spatial coordinates (i.e., the particular location range) associated with that component image's rectangle stored in the memory space.

The method of some embodiments correlates the first location to locations of two candidate component images in the first image. Because lines representing data message flows in a canvas are represented in the memory space as rectangles, different rectangles representing different data message flows can overlap in the memory space, namely the location ranges of these rectangles can share some of the same spatial coordinates. Because of this, if the method correlates the first location to two or more candidate component images, the method determines the particular component image from the candidate component images. To perform this determination, the method of some embodiments correlates the first location to locations corresponding to each endpoint of each candidate line, determines a potential length of each line based on the correlating, and compares the potential length of each candidate line to a known length of the candidate line to determine the particular component image. If the computed line length matches the known line length, the method determines that line to be the line over which the curser is hovering.

In some embodiments, the first image including the component images that are not selectable GUI elements is presented in the display area at a first set of one or more zoom levels of the GUI. In such embodiments, the method presents in the display area a second image of at least a subset of the several network elements in the network including selectable GUI elements corresponding to the at least subset of the network elements. The second image including the selectable GUI elements is presented in the display area at a second set of one or more zoom levels. The second image in some embodiments presents only a subset of the network, and the second image includes selectable GUI elements for only a subset of the network elements in the network. In some embodiments, the second set of zoom levels includes closer zoom levels than the first set of zoom levels. This is because, as a user zooms out to view more network elements of a large network, each network element cannot be a selectable GUI element without slowing down the rendering of the graph, so cursor location is utilized to make the network appear interactive to the user. As the user zooms in on the graph, and as less network elements are displayed because the user has zoomed in closer, each network element can be a selectable GUI element, so the method renders selectable items for the displayed subset of network elements for the user to interact with those network elements.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings, and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIGS. 1A-B illustrate examples network elements drawn on a canvas and their locations stored in a memory space.

FIG. 2 illustrates an example canvas image of a network graph of some embodiments.

FIG. 3 illustrates an example canvas image of a network graph represented in a memory space in some embodiments.

FIG. 4 conceptually illustrates a process of some embodiments for providing user interactivity for an overall image of a network in a canvas image in a GUI.

FIG. 5 illustrates an example GUI displaying a canvas image of a large network graph.

FIG. 6 illustrates an example GUI displaying selectable GUI elements for a small network graph.

FIG. 7 illustrates an example GUI displaying a network graph highlighting a machine in the network graph.

FIG. 8 illustrates an example GUI displaying a network graph highlighting a data message flow in the network graph.

FIG. 9 illustrates an example of a memory space that finds rectangles representing data message flows that are intersecting user cursor coordinates in some embodiments.

FIG. 10 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a novel method of providing user interactivity for a first image of a network. The method presents, in a display area of a graphical user interface (GUI), the first image of the network. The first image includes several component images corresponding to several network elements in the network. In some embodiments, none of the component images are GUI elements that are selectable in the GUI. The method detects a cursor action at a first location in the first image. The method identifies a particular component image by correlating the first location to a location of the particular component image in the first image. Then, the method performs a GUI action for a particular network element that corresponds to the particular component image.

Rendering a large network graph in a browser can be a challenge because of browser limitations. GUI element images (e.g., Scalable Vector Graphics (SVG) resembling Extensible Markup Language (XML)) are easy to use and are interactive. However, rendering thousands of objects using GUI elements causes the browser to slow down. Alternatively, a canvas or raster image (e.g., HTML5 Canvas) is able to render thousands of objects but it is not interactive, meaning that a graph drawn using a canvas is a bitmap image and does not respond to mouse movements, hovers, clicks or any other user actions. Adding interactivity to a large network graph drawn on a canvas image allows the objects drawn on the canvas, such as nodes and links, to be highlighted when a user clicks or moves the mouse on the graph. Because the number of objects drawn is in the hundreds of thousands in some embodiments, it is important that the interactivity is fast and does not lag, i.e., objects should be highlighted as soon as the mouse enters the boundaries of the object.

In some embodiments, one of the main components of adding interactivity to a canvas image is an in-memory graph representation using an RTree. An in-memory graph is maintained, which is a copy and model of the graph drawn on the canvas. The graph is stored in the RTree data structure and is used for storing spatial data such as coordinates. RTree is a very efficient data structure for searching coordinate data and is able to search hundreds of thousands of objects in milliseconds. If a graph is stored in memory in any other data structure, a linear search is conducted to find the matching objects. However, RTree is a performant data structure to query the coordinate data. The graph includes machines and data message flows which are represented as circles and lines. Since RTree does not store circles and lines, they are transformed to be stored in the RTree as rectangles in some embodiments.

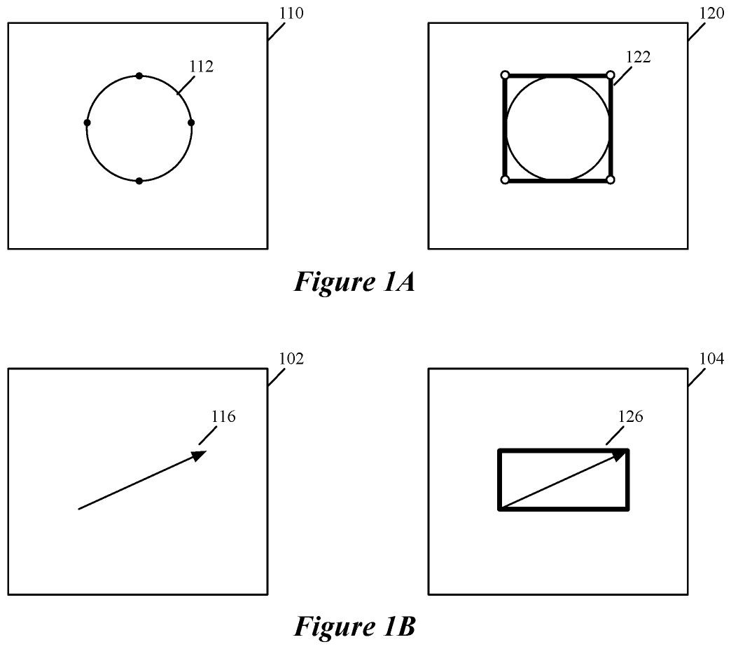

The network elements displayed in the GUI are described below to be machines. However, other types of network elements may be displayed in a GUI, such as switches, routers, middlebox elements, machines, and clusters of these network elements. FIG. 1A illustrates an example of a machine 112 drawn on a canvas 110 and how it is stored in a memory space 120. This machine may be a virtual machine (VM), node, container, pod, etc. The memory space 120 in this example is an RTree data structure. In some embodiments, machines are drawn on the canvas 110 in the shape of circles and represented as a center point along with a radius e.g., {x: 100, y: 100, r: 50}, as shown with the machine 112. The memory space 120 in some embodiments draws machines as rectangular shapes instead of circles, so a machine is stored in the memory space 112 as a square 122 encompassing the circle 112. The spatial coordinates spanned by that rectangle 122 are stored in the memory space 120 and are associated with the location of the machine's circle 112 drawn on the canvas 110, namely the pixels of the canvas covered by the circle's center point and radius). In doing so, the memory space 120 can be searched to find the location range of the machine's rectangle 122 which corresponds to the location range of the machine's circle 112 on the canvas 102, which provides the ability to interact with this machine on the canvas 102 via the machine's location. For network elements that are not machines (e.g., that are logical or physical forwarding elements, clusters, etc.), they can also be represented in a canvas image as circles and stored in the memory space 120 as rectangles.

FIG. 1B illustrates an example of a link 116 drawn on the canvas 110 and how it is stored in the memory space 120. In some embodiments, the link 116 represents a link between two machines in a network, namely a data message flow exchanged between these two machines. Links are in some embodiments represented as end points of (x1, y1) and (x2, y2) representing two coordinates from where the line starts to where the line ends, e.g., the source and destination machines of the flow. In some embodiments, the line 116 is drawn with a direction, as seen in this figure. However, in other embodiments, a line drawn on the canvas 110 is not drawn to indicate its direction.

Since a line is virtually an infinite set of points, a line is not stored in a memory as a representation of points. Instead, the line is stored as a rectangle 126 covering both the ends of the line 116, as shown on the memory space 120. In some embodiments, the direction of the flow is also recorded in a data storage. However, in other embodiments, the direction of a flow is not important so even if x2 or y2 is less than x1 or y1 (i.e., the difference between a first coordinate and second coordinate is negative), the memory representation is normalized to be a positive value. For example, for a line with a first endpoint of {1, 4} and a second endpoint of {3, 2}, and a difference between the first endpoint and the second endpoint is computed, which is {−2, 2}, the normalized difference which will be stored in the data storage is {2, 2}. The rectangle 126 that encompasses a line 116 representing a data message flow can be represented in the memory space 120 as a corner point, a height, and a width, e.g., {x: 100, y: 100, width: 200, height: 100}. In some embodiments, the corner point is the top left point of the rectangle 126. In other embodiments, the corner point is another corner point of the rectangle 126. This spatial data is stored in the memory space 120 in order to determine the location of each point along the line 116 drawn on the canvas 110.

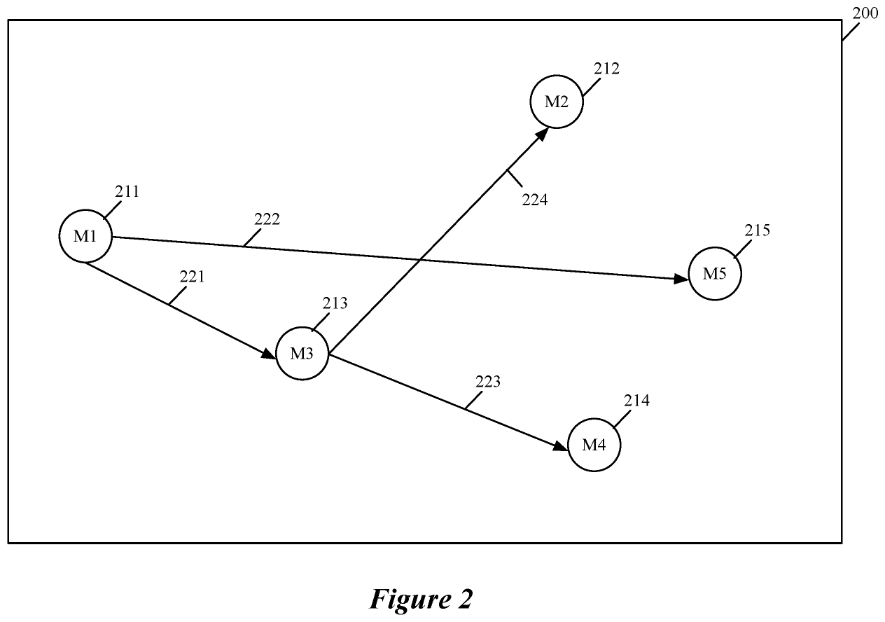

FIG. 2 illustrates an example of a network graph drawn on a canvas 200. This canvas 200 may be an HTML5 Canvas image. The network includes five machines 211-215, each drawn as an individual circle. Lines 221-224 are drawn between machines 211-215, representing different data message flows exchanged within the network. For example, a data message flow 222 is sent from the first machine 211 to the fifth machine 215, and another data message flow 223 is sent from the third machine 213 to the fourth machine 214. A network graph drawn on the canvas 200 can include any number of machines and any number of data message flows, e.g., 1,000 machines and 5,000 different data message flows exchanged between the machines.

Since canvas images are not interactive to a user action such as a click, hover, etc., a second graph is searched to find the object(s) on which a user has clicked/hovered on to highlight. In some embodiments, the second graph efficiently returns the objects intersecting with a rectangle and a 1×1 pixel square is created based on the user cursor coordinates. A search is then triggered on the memory space of the second graph to find the rectangles which are intersecting with this 1×1 pixel square. Since machines are stored as squares, the memory space in some embodiments finds the intersecting machine square and returns the machine object. This machine object is rendered on the canvas 200 as the highlighted machine and appears to be interactive. For example, if a user hovers a cursor over or clicks on the second machine 212 in the canvas 200, the memory space is searched to determine the rectangle corresponding to the cursor's location. Once this location is found in the memory space and is correlated to the rectangle associated with the second machine 212, the canvas highlights this machine in the canvas 200 for the user. The canvas 200 may also display additional information about the highlighted machine, such as the machine's name, the machine's network address, etc.

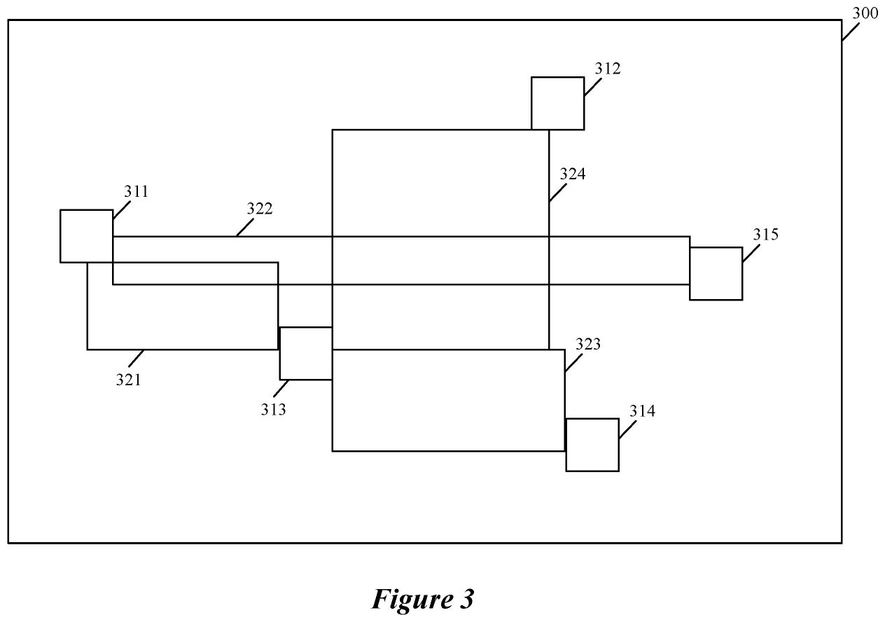

In a canvas, such as the canvas 200, all objects (i.e., all machines and data message flows) are drawn as component images of an overall image rendered on a graphical user interface (GUI). These component images are not interactive, meaning that they are not selectable GUI elements in the GUI. In order to “interact” with these non-interactive component images, some embodiments render another graph corresponding to the overall image that the user does not see in the GUI. This other graph stores location ranges spanned by each object rendered in the GUI, and a search is conducted for every cursor action taken by the user in the GUI. FIG. 3 illustrates the example of FIG. 2 represented as a graph in a memory space 300 at a high level. The memory space plots all machines and data message flows as rectangles and stores these locations in order to correlate a cursor location to an object drawn in a canvas. In this example, the five machines 311-315 are drawn in the memory space 300 as squares, and the four lines 321-324 are drawn as rectangles. These squares and rectangles cover the same location space as their associated machines and links drawn in FIG. 2.

As shown, some rectangles representing data message flows can overlap in the memory space 300. For example, the rectangles 321 and 322 respectively representing the links 221 and 222 overlap in the memory space 300. In some embodiments, a cursor action takes place at one of these overlapping locations, and the links represented by the overlapping rectangles are considered candidate links for which component image the user is interacting. A component image determination process is then determined to determine which component image the user is hovering or clicking on, which will be described further below.

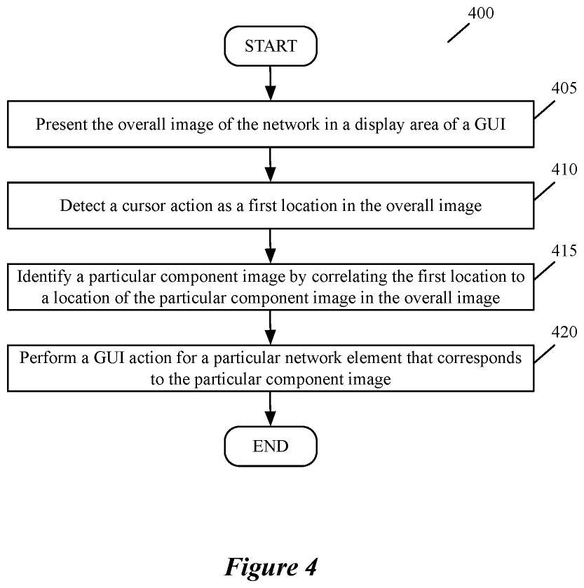

As discussed previously, in order to “interact” with a canvas image in a GUI, a user's cursor location is used along with data stored in a memory space to make the canvas image appear interactive to the user. FIG. 4 conceptually illustrates a process 400 of some embodiments for providing user interactivity for an overall image of a network. This process 400 may be performed for a GUI presenting a canvas image of a network graph to a user.

The process 400 begins by presenting (at 405), in a display area of a GUI, the overall image of the network. The overall image includes several component images corresponding to network elements in the network. None of these component images are GUI elements that are selectable in the GUI. In order to make these component images appear to be interactive to the user, a memory space stores location data for rectangles each representing an object drawn in the canvas, as discussed previously.

Next, the process 400 detects (at 410) a cursor action at a first location in the overall image. In some embodiments, the cursor action is detected by identifying that the first location is a current location of a cursor over the overall image. As a user moves a cursor (or a mouse) across the first image in the GUI's display area, the process 400 of some embodiments receives notification that the cursor has moved and receives spatial coordinates of the cursor. The method is able to use the cursor's current location to determine whether the cursor is hovering over any component images displayed in the GUI. In some embodiments, the cursor action is detected by detecting a cursor click operation at the first location in the first image, The cursor click operation may be either a single or double click operation, and may be either a right or left click operation.

At 415, the process 400 identifies a particular component image by correlating the first location to a location of the particular component image in the overall image. In some embodiments, the method correlates the first location to the location of the component image in the overall image by confirming that the first location falls within a particular location range allocated in a memory space associated with the particular component image. Each component image in some embodiments is represented in a memory space by a rectangle and the spatial coordinates of every point taken up by that rectangle corresponding to the pixel coordinates of the component image in the first image.

For instance, a rectangle is represented in a memory space for an object (e.g., a machine or a data message flow) displayed in a canvas image. In the canvas image, the object can be represented as another shape, such as a line or a circle, and the rectangle for that object is stored in the memory space as a collection of coordinates encompassing the entire line or circle. The spatial coordinates of the entire rectangle are associated with that object and the object's location on the canvas image. To confirm that a mouse cursor is hovering over or clicking on the object's component image in the canvas, the method determines that the cursor's location (i.e., the first location) has spatial coordinates that fall within the set of spatial coordinates (i.e., the particular location range) associated with that component image's rectangle stored in the memory space.

In some embodiments, the process 400 correlates the first location to locations of two candidate component images in the overall image. Because lines representing data message flows in a canvas are represented in the memory space as rectangles, different rectangles representing different data message flows can overlap in the memory space, namely the location ranges of these rectangles can share some of the same spatial coordinates. Because of this, if the method correlates the first location to two or more candidate component images, the method determines the particular component image from the candidate component images. further information regarding candidate component images and determining a component image from multiple candidates will be described below.

Next, the process 400 performs a GUI action for a particular network element that corresponds to the particular component image. This GUI action may be to highlight the particular component image in the GUI, and/or to display additional information about the particular network element in the GUI. In some embodiments, a GUI action may also be to start, stop, pause, or migrate the particular network element. In embodiments where the particular network element includes multiple components (e.g., a machine cluster, a logical forwarding element implemented by multiple physical forwarding elements, etc.), the GUI action provides a more detailed view of the subcomponents of the particular network element upon a cursor click operation (e.g., a double click operation over the particular network element in the canvas).

In some embodiments, if the cursor is hovering over a particular component image, the process 400 performs the GUI action by modifying the particular component image in the GUI by displaying the particular component image in a different representation. For instance, the particular component image may be represented in a bolded representation or a particular color representation in order to highlight the particular component image in the GUI for the user. The method may also or instead display in the display area data from a data storage regarding the particular network element. Data regarding a selected network element is in some embodiments only displayed upon a click or double click selection of the component image associated with the network element, and a hovering cursor action only highlights the component image.

In some embodiments, the selected network element is a particular data message flow exchanged between first and second machines in the network. In such embodiments, the data displayed in the display area can be at least one of (1) the number of data messages of the particular flow, (2) the direction of the particular flow (e.g., from the first machine to the second machine, or vice versa), and (3) an action applied to the data messages of the particular flow based on a particular middlebox service rule. The particular middlebox service rule may be, for example, a firewall rule, and the action applied to the data messages may be to allow, drop, or block the data message. In some embodiments, the firewall rule applied to the data messages of the flow is applied because no rule has yet to be defined for these data messages. This type of action can be referred to as “unprotected” because the set of firewall rules that are enforced in the network do not protect the network from these data messages (e.g., if they should be blocked or dropped). The particular component image presented in the GUI for a data message flow is in some embodiments a line from the first machine to the second machine in a particular color corresponding to the action applied to the data messages of the particular flow. For example, for allowed, blocked, or unprotected data messages, the color may be green, blue, and red, respectively. After the GUI action is performed, the process 400 ends.

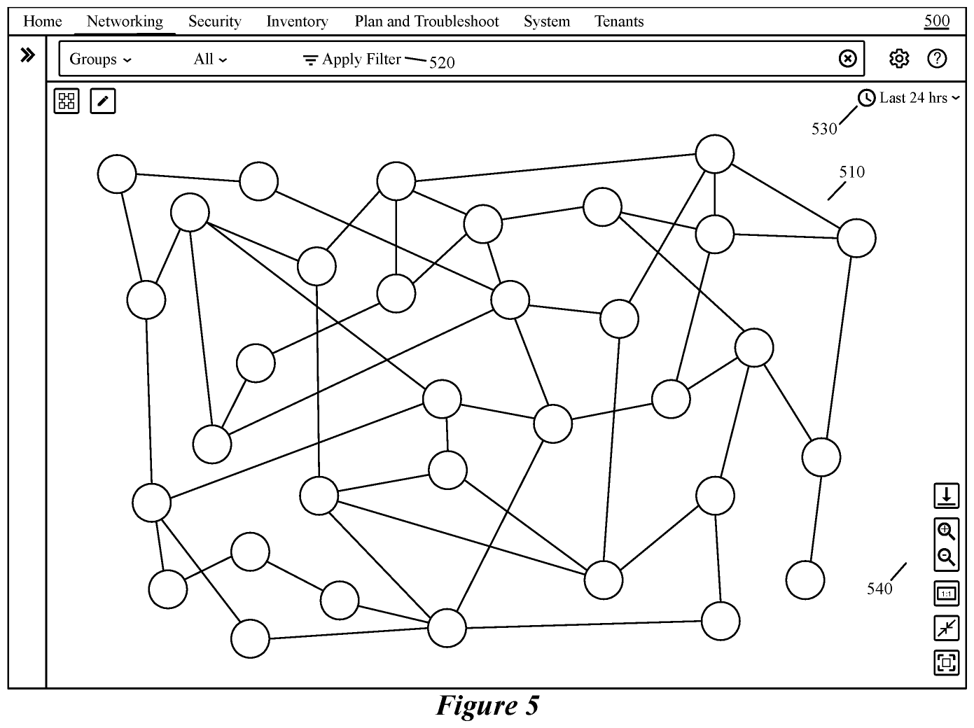

FIG. 5 illustrates an example GUI display area 500 presenting a network graph 510 the includes machines and connections between the machines. A network graph displayed in a GUI can include any number of machines and any number of connections representing data message flows exchanged within the network. In some embodiments, each machine is represented using an appearance that corresponds to an aspect about the machine. For example, different appearances can correspond to different types of machines (e.g., VMs, containers, pods, etc.). Different appearances can also correspond to source, destination, and intermediate machines of data message flows. Different appearances can also correspond to whether they allow, block, or reject data messages based on firewall rules applied to the data messages in some embodiments. In some embodiments, different appearances can also be used for connection links corresponding to different categories of data message flows. For example, if firewall rules are applied to the data message flows traversing the network, different appearances can correspond to whether the data message flow is allowed, blocked, or rejected. Different appearances can be different colors, different dashed or solid lines, different thicknesses of lines, different sizes, etc. In other embodiments, machines and/or connection links are represented using only a single appearance.

In some embodiments, a GUI display area 500 also provides different filters and selectable items for a user to customize the view of a network graph. An Apply filter 520 allows a user to filter what types of machines are to be presented. For instance, if the user wishes to only view VMs, and no containers or pods, the user can use the Apply filter 520 to accomplish this, and the GUI will display an updated network graph based on the filters and parameters set by the user. In this figure, no filters have been applied. The GUI display area 500 can also include a Time filter 530, for a user to view the network graph and its data message flows at different time periods. This figure shows the network and its data message flows within the last 24 hours. If a user decides to view the network graph during a different time period, the user uses the Time filter 530 to update the displayed graph. The GUI display area 500 can also include several selectable items 540, which can download the current graph as an image, can zoom the graph in and out, can show the graph in a 1:1 scale, can minimize the window of the GUI display area 500, and any suitable selectable items for displaying a network graph in a GUI.

A graph displayed in a GUI in some embodiments can be presented as a canvas or raster image (e.g., an HTML5 canvas image) or an interactive GUI image (e.g., an SVG image) depending on the zoom level of the graph. For a network including thousands or hundreds of thousands of machines and connection links, selectable GUI elements are only displayed for network elements when the user zooms in to view a small subset of the network elements. This is because, as a user zooms out to view more network elements of a large network, each network element cannot be a selectable GUI element without slowing down the rendering of the graph, so cursor location is utilized to make the network appear interactive to the user. As the user zooms in on the graph, and as less network elements are displayed because the user has zoomed in closer, each network element can be a selectable GUI element, so selectable items are rendered for the displayed subset of network elements for the user to interact with those network elements. For instance, for a network to be presented in a GUI, a first image including component images is presented at a first set of zoom levels, and a second image including selectable GUI elements is presented at a closer second set of one or more zoom levels.

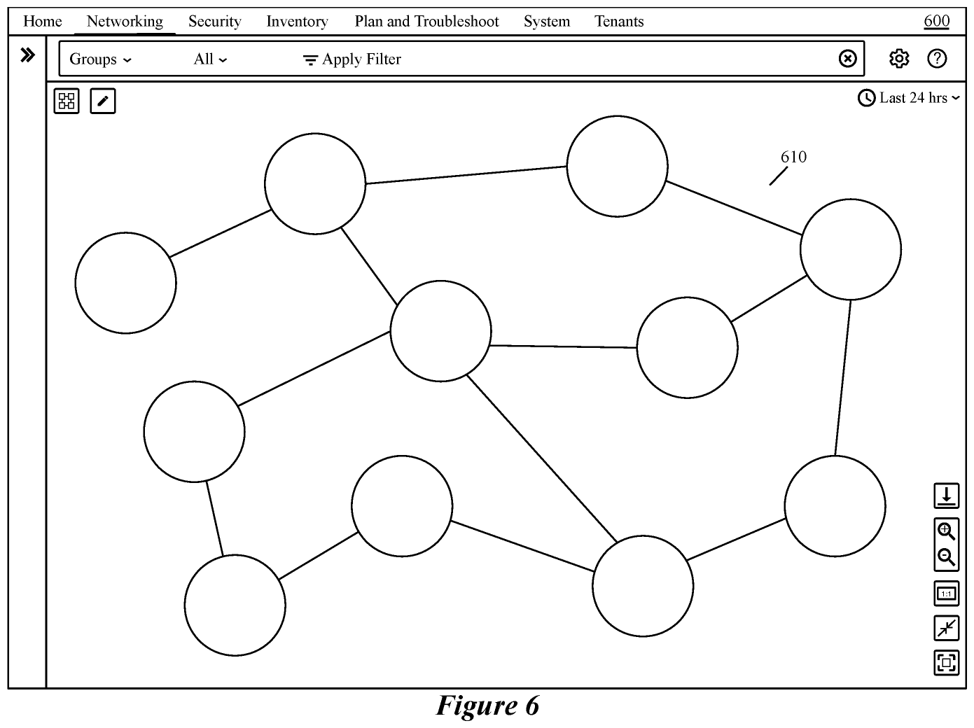

FIG. 5 illustrates the network graph 510 at a zoomed out level in the display area 500. In order to interact with the graph at this zoom level, cursor location detection is used resulting in the image appearing interactive to the user. FIG. 6 illustrates a GUI display area 600 displaying a subset of the network 610. In this figure, a user has zoomed on the network graph to view a smaller subset of the network elements. Because there is a smaller number of network elements to render, the GUI displays this network graph 610 using interactive GUI elements, meaning that each machine and connection link represented in the graph 610 is a selectable GUI element. In some embodiments, the selectable GUI elements for the network elements are presented at closer zoom levels, and as the user zooms out on the graph, the GUI changes the display of the network to be non-selectable GUI elements instead. A particular zoom level may be used as a threshold for the GUI to determine when to render a canvas image and when to render selectable GUI elements for the network. When a user changes the zoom level of the GUI display area and crosses the threshold, the GUI changes the type of image rendered in the display area.

In sum, component images that are not selectable GUI elements are not selectable because they are not defined in a UI program as selectable items. Because of this, the cursor location process of FIG. 4 is used. Specifically, in some embodiments, a UI defines the 11 machines in the graph 610 (e.g., instances of a machine class) and the 11 connection links in the graph 610 to represent the 11 circles and 11 lines shown in FIG. 6, draws these objects by using, e.g., SVG, and natively captures user interactions (e.g., cursor interactions) with these 22 machine and connection link objects. On the other hand, the UI program in these embodiments does not define any machine or connection link objects for any of the machines or connection links displayed in FIG. 5, as none of these machines or connection links are selectable items that the UI program defines. Rather, these machines and connection links are only component images of the canvas image displayed in the display area 500 of the GUI. Hence, some embodiments use the process 400 of FIG. 4 to enable the user to perceive these machines and connection links as selectable items in the GUI by mapping the position of the cursor that is used by the user to the position of the individual machines and connection links, and then providing UI feedback and/or actions with respect to the individual machines and connection links.

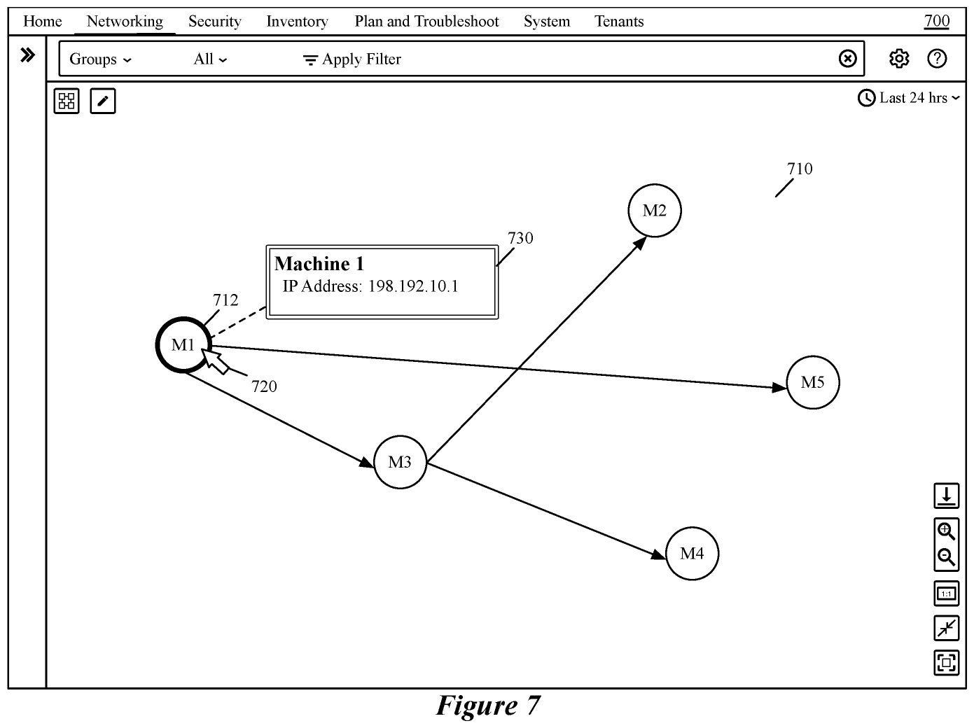

Regardless of whether a GUI uses interactive GUI elements or cursor location detection, the GUI can present additional information for a selected network element. FIG. 7 illustrates an example GUI display area 700 displaying a network 710. This image is rendered to show the machines of the network and the data message flows exchanged between the machines. The data message flows of the network 710 are shown here to indicate the direction of the flow. Different embodiments may indicate or not indicate flow direction in a presented network graph. In this example, a machine 712 is highlighted due to an action taken by a cursor 720. This cursor action may be a hovering action or a cursor click operation in different embodiments.

In this figure, the machine 712 has been bolded to show to the user that this machine has been highlighted. In some embodiments, the machine 712 is also or instead shown in the GUI in a different color than the rest of the objects drawn in the GUI. Any suitable appearance may be used to present the selected machine in the GUI display area 700. The cursor movement and/or action taken by the user's cursor 720 in some embodiments triggers an additional display window 730 to be displayed in the GUI. This display window 730 shows additional information regarding the highlighted machine 712. In this example, the machine's name and Internet Protocol (IP) address are shown to the user. Any suitable information regarding a machine of a network may be displayed in the display window 730.

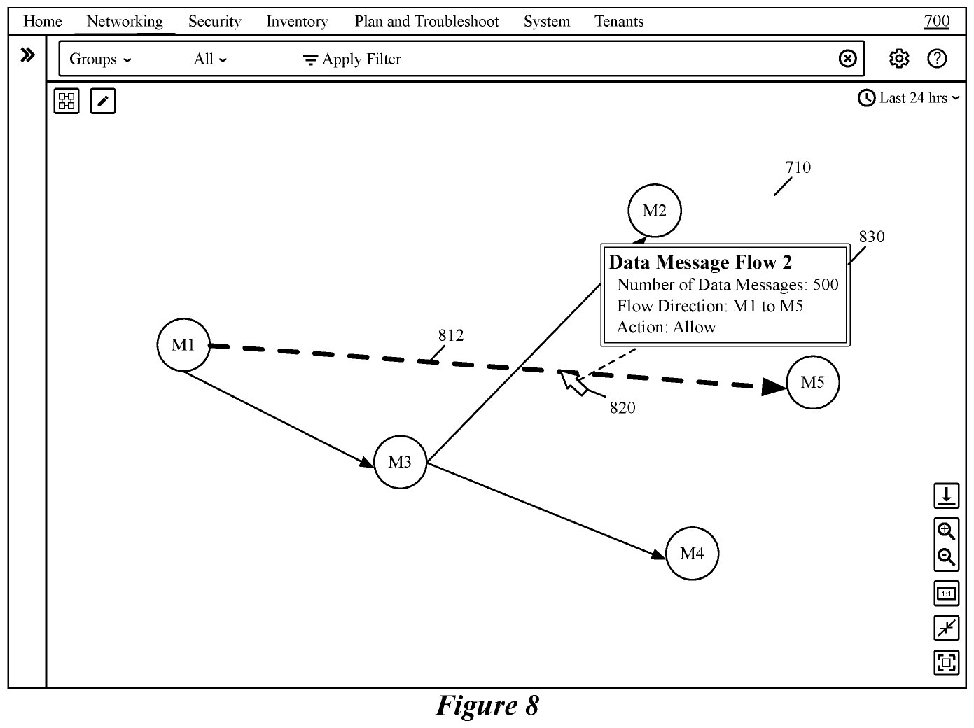

FIG. 8 illustrates the same GUI display area 700 displaying the network 710. In this figure, a data message flow 812 is highlighted due to an action taken by a cursor 820. As discussed previously, this cursor action may be a cursor hover and/or click operation. Because of this cursor action taken by the user, the data message flow 812 is bolded and is shown as a dashed line. In some embodiments, the highlighted line 812 may be displayed in any bolded representation, any solid or dashed representation, and/or in any color representation. For example, if the line 812 represents an allowed, blocked, or rejected flow, the line may be green, blue, or red, respectively.

This figure also shows an additional display window 830 displaying to the user additional information regarding the selected data message flow. The display window 830 shows in this example the number of data messages of the flow (500 data messages), the direction of the flow (from machine 1 to machine 5), and the action taken on these data message of the flow based on a middlebox service rule (allow). The action shown in the display window 830 for the flow 810 is “allow,” meaning that the data messages of this flow had one or more firewall rules applied to them, and the action taken was to allow them to be sent to the destination machine. Any information regarding any data message flow in a network may be displayed in the window 830.

As discussed previously, because lines representing data message flows in a canvas are represented in the memory space as rectangles, different rectangles representing different data message flows can overlap in the memory space, namely the location ranges of these rectangles can share some of the same spatial coordinates. Because of this, if a location of a cursor is correlated to two or more candidate component images of one overall image in a GUI, steps need to be taken to determine which of the candidate component images the user is actually hovering over or clicking on in the GUI.

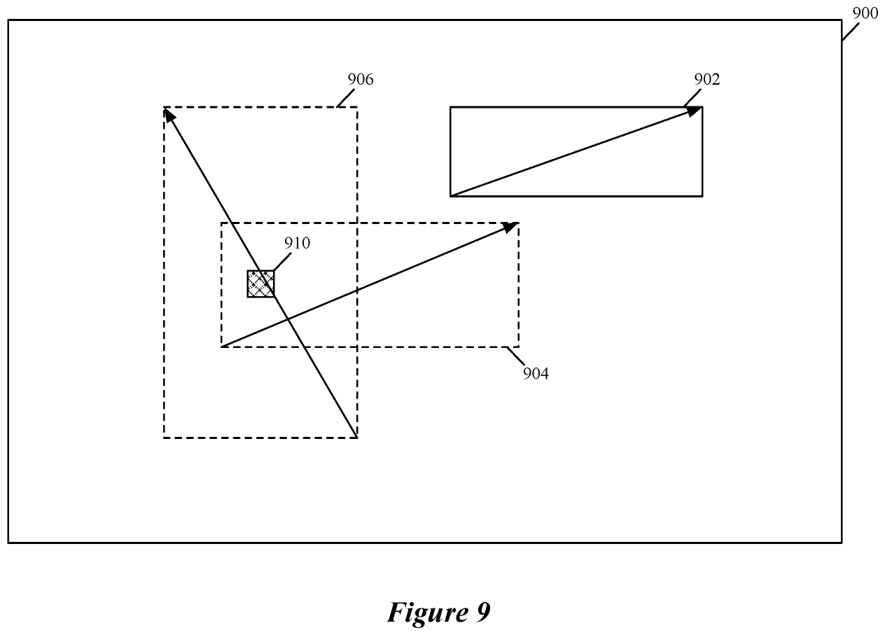

FIG. 9 illustrates an example of a memory space 900 finding rectangles that are intersecting with a 1×1 pixel square (the user mouse coordinates) in some embodiments. Because links are stored as rectangles in the memory space 900, the memory space is not able to determine the exact link that the user is hovering on and a postprocessing is required after the memory space search to correlate the cursor location to the candidate component images. Three links are shown as rectangles 902, 904, and 906, and the cross-hatched 1×1 pixel square 910 (displayed in some embodiments as red on a display screen of the GUI) is the user mouse coordinates. The memory space 900 will return the candidate (displayed as dashed lines in the figures but blue on a display screen in some embodiments) links 904 and 906, and which are displayed as dashed rectangles. Because the cursor location 904 falls within the location range of these two rectangles 904 and 906, a second level processing is performed to find the exact line on which the user is hovering.

To perform this determination, the cursor's location is correlated to locations corresponding to each endpoint of each candidate line, a potential length of each line is determined based on the correlating, and the potential length of each candidate line is compared to a known length of the candidate line to determine the particular component image. If the computed line length matches the known line length, that line is determined to be the line over which the curser is hovering. More specifically, this is done by calculating the distance from the mouse coordinate to both ends of the line and calculating the length of line and equating it. For example, if the mouse coordinate is “const mouseCoord={x, y}”, then

dist(line.start,line.end)==(dist(line.start,mouseCoord)+dist(mouseCoord,line.end)).

If this calculation is true, the line that the user is hovering on is found and is drawn on the canvas as the highlighted line. In this example, the line represented by the rectangle 906 is the line on which the user is hovering or clicking, and this line will be highlighted in the GUI for the user.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

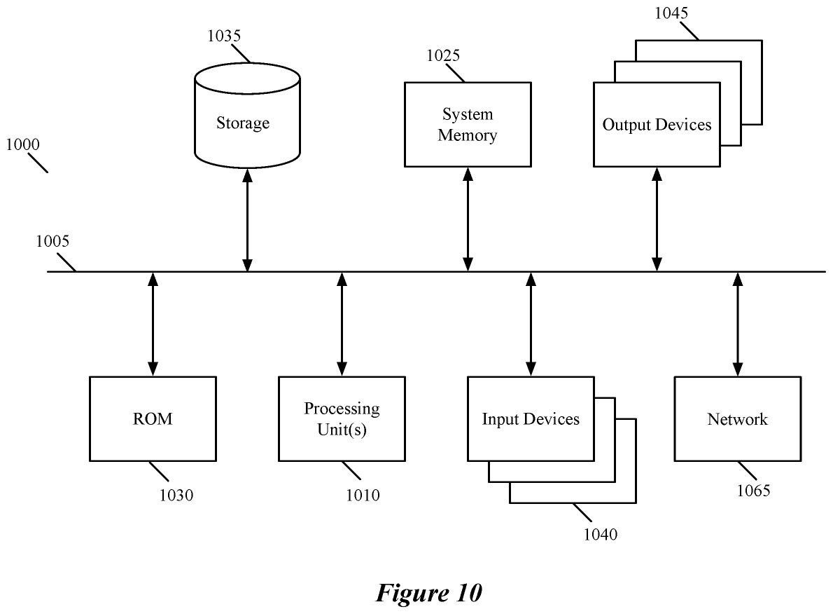

FIG. 10 conceptually illustrates a computer system 1000 with which some embodiments of the invention are implemented. The computer system 1000 can be used to implement any of the above-described computers and servers. As such, it can be used to execute any of the above described processes. This computer system includes various types of non-transitory machine readable media and interfaces for various other types of machine readable media. Computer system 1000 includes a bus 1005, processing unit(s) 1010, a system memory 1025, a read-only memory 1030, a permanent storage device 1035, input devices 1040, and output devices 1045.

The bus 1005 collectively represents all system, peripheral, and chipset buses that communicatively connect the numerous internal devices of the computer system 1000. For instance, the bus 1005 communicatively connects the processing unit(s) 1010 with the read-only memory 1030, the system memory 1025, and the permanent storage device 1035.

From these various memory units, the processing unit(s) 1010 retrieve instructions to execute and data to process in order to execute the processes of the invention. The processing unit(s) may be a single processor or a multi-core processor in different embodiments. The read-only-memory (ROM) 1030 stores static data and instructions that are needed by the processing unit(s) 1010 and other modules of the computer system. The permanent storage device 1035, on the other hand, is a read-and-write memory device. This device is a non-volatile memory unit that stores instructions and data even when the computer system 1000 is off. Some embodiments of the invention use a mass-storage device (such as a magnetic or optical disk and its corresponding disk drive) as the permanent storage device 1035.

Other embodiments use a removable storage device (such as a flash drive, etc.) as the permanent storage device. Like the permanent storage device 1035, the system memory 1025 is a read-and-write memory device. However, unlike storage device 1035, the system memory is a volatile read-and-write memory, such a random access memory. The system memory stores some of the instructions and data that the processor needs at runtime. In some embodiments, the invention's processes are stored in the system memory 1025, the permanent storage device 1035, and/or the read-only memory 1030. From these various memory units, the processing unit(s) 1010 retrieve instructions to execute and data to process in order to execute the processes of some embodiments.

The bus 1005 also connects to the input and output devices 1040 and 1045. The input devices enable the user to communicate information and select commands to the computer system. The input devices 1040 include alphanumeric keyboards and pointing devices (also called “cursor control devices”). The output devices 1045 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 10, bus 1005 also couples computer system 1000 to a network 1065 through a network adapter (not shown). In this manner, the computer can be a part of a network of computers (such as a local area network (“LAN”), a wide area network (“WAN”), or an Intranet, or a network of networks, such as the Internet. Any or all components of computer system 1000 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method of providing user interactivity for a first image of a network, the method comprising:
presenting, in a display area of a graphical user interface (GUI), the first image of the network, the first image comprising a plurality of component images corresponding to a plurality of network elements in the network, wherein none of the component images are GUI elements that are selectable in the GUI;
detecting a cursor action at a first location in the first image;
identifying a particular component image by correlating the first location to a location of the particular component image in the first image; and
performing a GUI action for a particular network element that corresponds to the particular component image.

2. The method of claim 1, wherein:
detecting the cursor action comprises identifying the first location as a current location of a cursor over the first image, and
performing the GUI action comprises modifying the particular component image in the GUI by displaying the particular component image in a different representation.

3. The method of claim 2, wherein the different representation comprises at least one of (i) a bolded representation of the particular composite image, and (ii) a particular color representation of the particular component image.

4. The method of claim 2, wherein performing the GUI action further comprises displaying, in the display area, data from a data storage regarding the particular network element.

5. The method of claim 1, wherein:
detecting the cursor action comprises detecting a cursor click operation at the first location in the first image, and
performing the GUI action comprises displaying, in the display area, data from a data storage regarding the particular network element.

6. The method of claim 5, wherein the cursor click operation comprises one of a single right click operation or a single left click operation.

7. The method of claim 6, wherein the cursor click operation comprises one of a double right click operation or a double left click operation.

8. The method of claim 5, wherein the particular network element is a machine of the network.

9. The method of claim 8, wherein the data comprises at least one of a name of the machine and a network address of the machine.

10. The method of claim 5, wherein the particular network element is a particular data message flow exchanged between first and second machines in the network.

11. The method of claim 10, wherein the data comprises data regarding at least one of (i) a number of data messages of the particular data message flow, (ii) a direction of the particular data message flow, and (iii) an action applied to data messages of the particular data message flow based on a particular middlebox service rule.

12. The method of claim 11, wherein the particular component image is presented in the GUI as a line from the first machine to the second machine in a particular color corresponding to the action applied to the data messages of the particular data message flow.

13. The method of claim 1, wherein:
detecting the cursor action comprises identifying the first location as a current location of a cursor over the first image, and
performing the GUI action comprises displaying, in the display area, data from a data storage regarding the particular network element.

14. A method of providing user interactivity for a first image of a network, the method comprising:
presenting, in a display area of a graphical user interface (GUI), the first image of the network, the first image comprising a plurality of component images corresponding to a plurality of network elements in the network, wherein none of the component images are GUI elements that are selectable in the GUI;
storing, in a memory, a in-memory graph that stores for each component image a range of locations occupied by the component image in the GUI;
detecting a cursor action at a first location in the first image;
identifying a particular component image by confirming that the first location falls within a particular range of locations allocated in the in-memory graph to the particular component image;
performing a GUI action for a particular network element that corresponds to the particular component image.

15. The method of claim 14, wherein the plurality of network elements comprise a plurality of machines and a plurality of data message flows exchanged between machines in the plurality of machines.

16. The method of claim 15, wherein the particular network element is a particular data message flow, and identifying the component image comprises:
correlating the first location to locations of two or more candidate component images in the first image, and
determining the particular component image from the two or more candidate component images.

17. The method of claim 16, wherein determining the identified component image from the two or more candidate component images comprises:
correlating the first location corresponding to each endpoint of each candidate component image;
determining a potential length of each candidate component image based on the correlating; and
comparing the potential length of each candidate component image to a known length of the candidate component image to determine the particular component image.

18. The method of claim 1, wherein the first image comprising the plurality of component images is presented in the display area at a first set of one or more zoom levels of the GUI, the method further comprising presenting, in the display area, a second image of at least a subset of the plurality of network elements in the network comprising a plurality of selectable GUI elements corresponding to the at least subset of the plurality of network elements in the network, wherein the second image comprising the selectable GUI elements is presented in the display area at a second set of one or more zoom levels of the GUI.

19. The method of claim 18, wherein the second set of zoom levels comprises closer zoom levels than the first set of zoom levels.

20. The method of claim 19, wherein the second image presents only a subset of the network and the second image comprises the plurality of selectable GUI elements for only a subset of the plurality of network elements in the network.

21. A non-transitory machine readable medium storing a program for execution by a set of one or more processing units for providing user interactivity for a first image of a network, the program comprising sets of instructions for:
presenting, in a display area of a graphical user interface (GUI), the first image of the network, the first image comprising a plurality of component images corresponding to a plurality of network elements in the network, wherein none of the component images are GUI elements that are selectable in the GUI;
detecting a cursor action at a first location in the first image;
identifying a particular component image by correlating the first location to a location of the particular component image in the first image; and
performing a GUI action for a particular network element that corresponds to the particular component image.
